(19) United States
(12) Patent Application Publication
(10) Pub. No.: US 2025/0085546 A1
(43) Pub. Date: Mar. 13, 2025

(54) HEAD MOUNTED IMAGING APPARATUS WITH ROTATING OPTICAL COUPLING

(71) Applicant: Vuzix Corporation, West Henrietta, NY (US)

(72) Inventor: Robert J. Schultz, Victor, NY (US)

(21) Appl. No.: 18/726,657

(22) PCT Filed: Jan. 3, 2023
(86) PCT No.: PCT/US2023/010052

§ 371 Date: Jul. 3, 2024

Related U.S. Application Data
(60) Provisional application No. 63/296,338, filed on Jan. 4, 2022.

(51) Int. Cl. G02B 27/01; G02B 5/18; G02B 6/34; G02B 27/00

(52) U.S. Cl. CPC G02B 27/0172; G02B 5/1819; G02B 6/34; G02B 27/0081; G02B 2027/0178

(57) ABSTRACT

A virtual image display apparatus including a projector operable to direct image-bearing light beams along a projection axis, a waveguide having an in-coupling diffractive optic and an out-coupling diffractive optic, wherein the waveguide is oriented at an obtuse angle with respect to the projection axis, and an optical coupler configured to receive the image-bearing light beams along the projection axis, reorient the projection axis to an acute angle of incidence with respect to the waveguide, rotate the image-bearing light beams from a first orientation to a second orientation with respect to the projection axis, and direct the rotated image-bearing light beams along the reoriented projection axis to the in-coupling diffractive optic.

### TECHNICAL FIELD

The present disclosure generally relates to electronic displays, and more particularly to optical image light guide systems with diffractive optics operable to convey image-bearing light to a viewer.

### BACKGROUND

Head-Mounted Displays (HMDs) are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

In general, HMD optics must meet a number of basic requirements for viewer acceptance, including sufficient eye relief or eye clearance. The eye relief range is defined by viewer comfort and the optical configuration of the human eye itself. In practice, the distance between the last optical surface of the HMD optics and the viewer's eye is preferably above about 20 mm. An additional requirement is appropriate pupil size. Pupil size requirements are based on physiological differences in viewer face structure as well as on gaze redirection during viewing. An entrance pupil size of at least about 10 mm diameter has been found to be desirable. In addition, a wide field of view (FOV) is preferable. For many visual tasks, such as targeting and object recognition, a FOV approaching about fifty-degrees is considered to be desirable. Further, the virtual image that is generated should have sufficient brightness for visibility and viewer comfort.

The first three requirements identified above concern the eyebox. The eyebox relates to the volume within which the eye of the observer can comfortably view the image. The size of the eyebox depends in part on the length of the path of the light from the image source to where the image is viewed and image source size, and in part on the divergence of the image source and/or the collimation of the light after its emission by the image source. The desirable size of the eyebox depends largely on the quality of viewing experience that is desired from the display.

In addition to optical requirements, HMD designs must also address practical factors such as variable facial geometry, acceptable form factor with expectations of reduced size for wearing comfort, weight, cost, and ease of use.

A goal for most HMD systems is to make the imaging/relay system as compact as possible; however, when using conventional optics, there are basic limits. The output of the optical system must have a pupil that is large enough to support a reasonably sized virtual image and also allow for some movement of the eye. In a binocular system there is also the issue of varying intraocular distances (e.g., interpupillary distance) among different users and the need for the output pupil of the optical system to allow for this.

In a number of HMD image light guide arrangements, collimated, relatively angularly encoded light beams from an image source are coupled into a planar waveguide by an input coupling such as an in-coupling diffractive optic, which can be mounted or formed on one or more of the surfaces of the planar waveguide and/or buried within the waveguide. Such diffractive optics can be formed as diffraction gratings, holographic optical elements or in other known ways. For example, a diffraction grating can be formed by surface relief. After propagating along the waveguide via total internal reflection (TIR), image-bearing light can be directed back out of the waveguide by an output coupling optic such as an out-coupling diffractive optic, which can be arranged to provide pupil expansion in one or more directions.

Such waveguides enable lateral translation of the exit pupil of a projection system so that the projection system can be located to the side of the viewing path, such as alongside the viewer's head. Waveguides also expand the exit pupil (i.e., eyebox) in one or more dimensions so that the size of the projection system can be reduced. This allows the exit pupil of the projection system to be quite small while enlarging the eyebox and allowing the system to be moved out of the viewer's line of site. At the same time, the waveguide can be transparent, so the virtual image can be superimposed over the ambient environment.

With the bulk of the projection optics laterally translated out of the user's view and highly compact, there is still a desire to configure the projection components to a form factor that is more consistent with glasses and thus more acceptable to a broad user population. A number of approaches have been proposed for using a prism or mirror to fold the optical path. However, the net effect has often been awkward placement of projection components, such as having these components further removed from the waveguide, increasing the dimensional requirements of the head-mounted device.

Another difficulty with conventional approaches relates to imaging aspect ratios and device form factors that are conventionally used for projection devices and that have been adapted for use with micro-projectors and so-called “pico-projector” devices. The imaging height:width aspect ratio for projection is 9:16. Projection devices are correspondingly designed with a larger horizontal (width) dimension and a shorter vertical (height) dimension. This makes it awkward to employ a conventional projector design with a HMD waveguide; a more suitable aspect ratio would be achieved by rotating the projector ninety-degrees and allowing the projector to fit snugly against the viewer's head, rather than to extend horizontally outward. The usable image area, however, would be reduced by such an arrangement.

There is thus a need for an HMD that allows projector rotation and seating of the projector against the side of the viewer's head.

### SUMMARY

It is an object of the present disclosure to advance the art of virtual image presentation using head-mounted devices. Advantageously, embodiments of the present disclosure provide light coupling solutions that are compatible with the general form factor of eyeglasses and allow the use of projector optics that are rotated and fitted against the side of the viewer's head.

These and other aspects, objects, features and advantages of the present invention will be more clearly understood and appreciated from the following detailed description of the embodiments and appended claims, and by reference to the accompanying drawings. In a first exemplary embodiment, the present disclosure provides a virtual image display apparatus including a projector operable to direct image-bearing light beams along a projection axis, a waveguide having an in-coupling diffractive optic and an out-coupling diffractive optic, wherein the waveguide is oriented at an obtuse angle with respect to the projection axis, and an optical coupler configured to receive the image-bearing light beams along the projection axis, reorient the projection axis to an acute angle of incidence with respect to the waveguide, rotate the image-bearing light beams from a first orientation to a second orientation with respect to the projection axis, and direct the rotated image-bearing light beams along the reoriented projection axis to the in-coupling diffractive optic.

In an embodiment, the optical coupler includes a first surface configured to receive the image-bearing light along the projection axis, a second surface configured to redirect the projection axis toward a third surface, the third surface configured to redirect the projection axis toward a fourth surface, the fourth surface configured to redirect the projection axis toward the second surface.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1A shows a schematic top view of a HMD according to an exemplary embodiment of the presently disclosed subject matter.

FIG. 1B shows a perspective view of a portion of an HMD according to FIG. 1A.

FIGS. 2A, 2B, and 2C show schematically how a planar waveguide operates to translate an incident light beam.

FIG. 2D shows a schematic top view of a portion of an HMD according to FIG. 1A.

FIG. 2E shows a schematic side view of a portion of an HMD according to an exemplary embodiment of the presently disclosed subject matter.

FIGS. 3A and 3B show perspective views of an optical coupler according to an exemplary embodiment of the presently disclosed subject matter.

FIGS. 4A, 4B, and 4C show perspective views of a projection axis/optical path through the optical coupler according to FIG. 3A.

FIG. 5 shows a schematic perspective view of projection axis/optical path through the optical coupler according to FIG. 3A.

FIGS. 6A, 6B, 6C, and 6D show top, left side, front, and right side views of the optical coupler according to FIG. 3A.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person, or machine, who wears and/or views images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling”, in the context of optics, refer to a connection by which light travels from one optical medium or device to another optical medium or device.

Where used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

Where used herein, the term “oblique” means at an angle that is not an integer multiple of ninety degrees (90°). Two lines, linear structures, or planes, for example, are considered to be oblique with respect to each other if they diverge from or converge toward each other at an angle that is at least about five-degrees (5°) or more away from parallel, or at least about five-degrees (5°) or more away from orthogonal. An “obtuse angle” is larger than ninety degrees (90°) but less than one-hundred-eighty degrees (180°).

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOEs) or in other known ways. For example, the diffraction grating can be formed by surface relief After propagating along the waveguide, the diffracted light can be directed back out of the waveguide by a similar output coupling such as an out-coupling diffractive optic, which can be arranged to provide pupil expansion along at least one direction. In addition, a turning grating can be positioned on/in the waveguide to provide pupil expansion in at least one other direction. The image-bearing light output from the waveguide provides an expanded eyebox for the viewer.

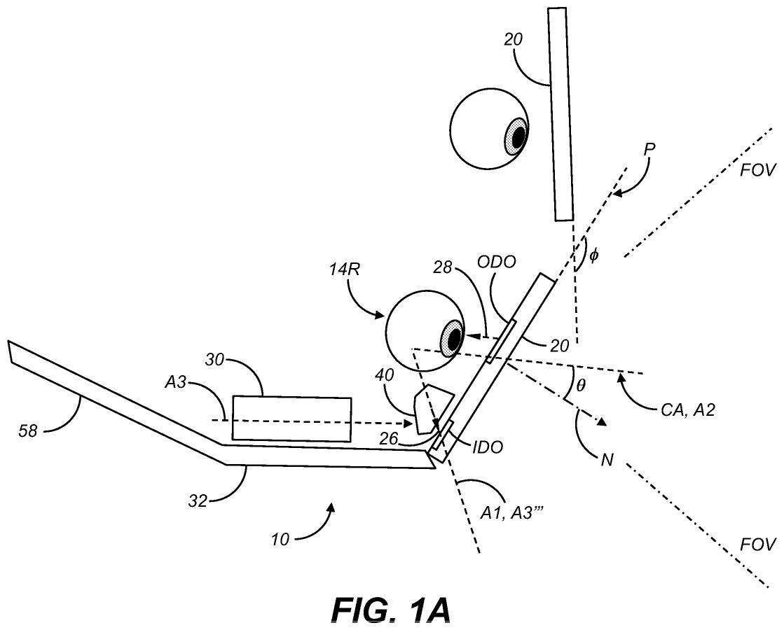

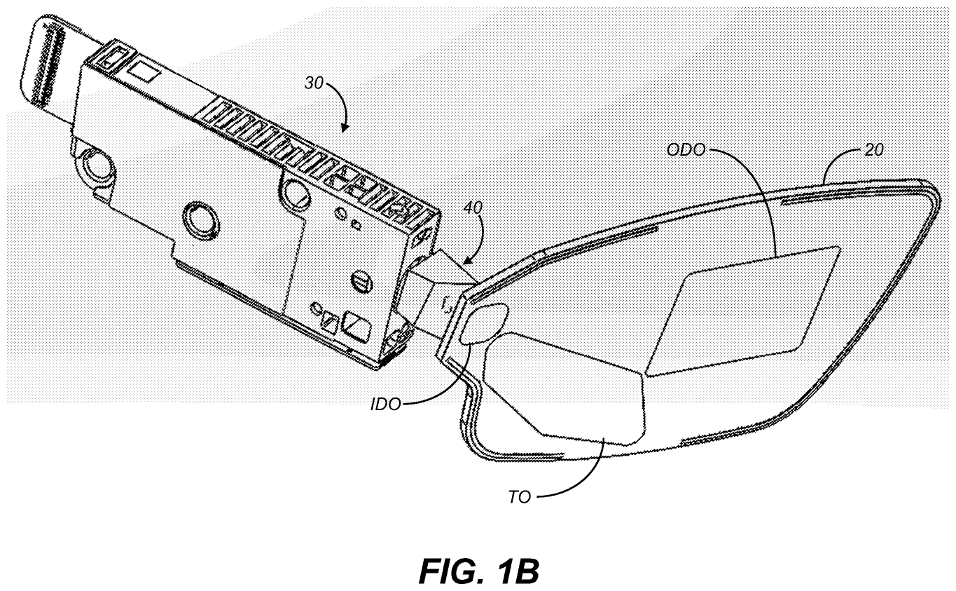

The schematic diagram of FIG. 1A shows, in top view, an exemplary embodiment of a HMD 10 with a frame 58 (shown in partial detail to increase clarity). The HMD 10 provides a near-eye display, as the term is understood by those skilled in the relevant arts. In the description that follows, the optical path components, spacing, and constraints are described with reference to the right eye 14R of an observer as represented in FIG. 1A. The same characteristics and constraints can optionally apply for the left eye, with parallel components and corresponding changes in component positioning. Therefore, the HMD 10 encompasses both a monocular optical imaging apparatus and a binocular imaging apparatus.

As illustrated in FIG. 1A, in an embodiment, two planar waveguides 20 are disposed at an obtuse “chevron” angle ϕ with respect to each other. A monocular system, according to an embodiment of the present disclosure, would provide a single projector 30 and corresponding waveguide 20, along with supporting optics as described in more detail subsequently. The observer has a corresponding ambient field of view (FOV) or view path through the transparent waveguide 20. The FOV is substantially centered about a center axis CA that can be normal or oblique to the planar waveguide 20. In the exemplary system of FIG. 1A, axis CA is oblique, at an angle θ from a normal N, to the surface(s) of waveguide 20. Waveguide 20 is the last optical element provided by HMD 10 for forming/conveying the virtual image to the eyebox.

The waveguide 20 is formed of glass or other transparent optical material. In an embodiment, the waveguide 20 includes an in-coupling diffractive optic IDO and an out-coupling diffractive optic ODO that cooperate to resize and redirect an incident image-bearing light beam 26. Persons skilled in the relevant art will recognize that the accompanying drawings illustrate a central ray of the referenced beams for the sake of clarity. The in-coupling diffractive optic IDO couples the image-bearing light 26 from a real image source into the substrate of the planar waveguide 20. Any real image or image dimension is first converted into an array of overlapping angularly related beams encoding the different pixel positions within an image for presentation to the in-coupling diffractive optic IDO. The image-bearing light 26 is diffracted and at least a portion of the image-bearing light 26 is thereby redirected by the in-coupling diffractive optic IDO into the planar waveguide 20 as image-bearing light for further propagation along the planar waveguide 20 by TIR. Although diffracted into a generally more condensed range of angularly related beams in keeping with the boundaries set by TIR, the in-coupled image-bearing light preserves the image information in an encoded form. The out-coupling diffractive optic ODO receives the encoded image-bearing light and diffracts at least a portion of the image-bearing light out of the planar waveguide 20 as the image-bearing light 28 toward the intended location of a viewer's eye. Generally, the out-coupling diffractive optic ODO is designed symmetrically with respect to the in-coupling diffractive optic IDO to restore the original angular relationships of the image-bearing light 26 among outputted angularly related beams of the image-bearing light 28. However, to increase one direction of overlap among the angularly related beams in the eyebox within which the virtual image can be seen, the out-coupling diffractive optic ODO is arranged to encounter the image-bearing light multiple times and to diffract only a portion of the image-bearing light on each encounter. The multiple encounters along the length of the out-coupling optic ODO in the direction of propagation have the effect of expanding one direction of the eyebox within which the image-bearing light beams overlap. The expanded eyebox decreases sensitivity to the position of a viewer's eye for viewing the virtual image.

Out-coupling diffractive optics with refractive index variations along a single direction can expand one direction of the eyebox in their direction of propagation along the waveguide via multiple encounters of the image-bearing light beams with the out-coupling diffractive optic causing replication of the out-coupled image-bearing light beam. In addition, out-coupling diffractive optics with refractive index variations along a second direction can expand a second direction of the eyebox and provide two-directional expansion of the eyebox. The refractive index variations along a first direction of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second direction of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

As illustrated in FIG. 1B, in an embodiment, the waveguide 20 includes an intermediate optic TO oriented to diffract a portion of the in-coupled image-bearing light toward the out-coupling diffractive optic ODO. The intermediate optic TO may be referred to herein as a turning grating or turning optic. In an embodiment, the intermediate optic TO is a surface relief grating. In another embodiment, the intermediate optic TO is a holographic optical element. The intermediate optic TO is operable to replicate, and/or turn the direction of propagation of, a portion of image-bearing light beams traveling within the waveguide 20 in one or more directions or dimensions, providing pupil expansion in one or more directions or dimensions. The intermediate optic TO may instead comprise a reflector array as described in US 2021/0215941 A1, incorporated herein by reference in its entirety.

Although the HMD 10 is illustrated as a “smart glasses” system, it should be appreciated that the present disclosure applies equally to Heads-Up Displays (HUDs) with different positioning of the waveguide(s) 20, image source systems 30, associated drive electronics, memory, and processor. For example, without limitation, the HMD 10 may be configured to resemble and/or be integrated with eyeglasses, ski goggles, swim goggles, and a helmet.

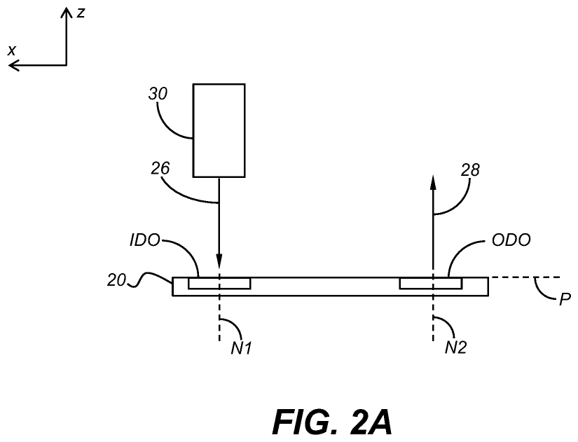

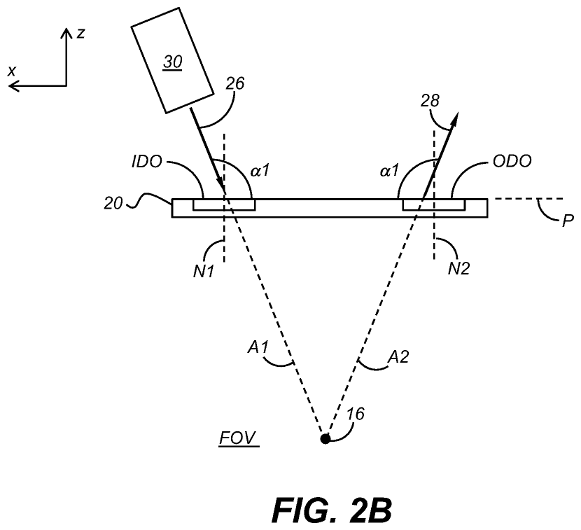

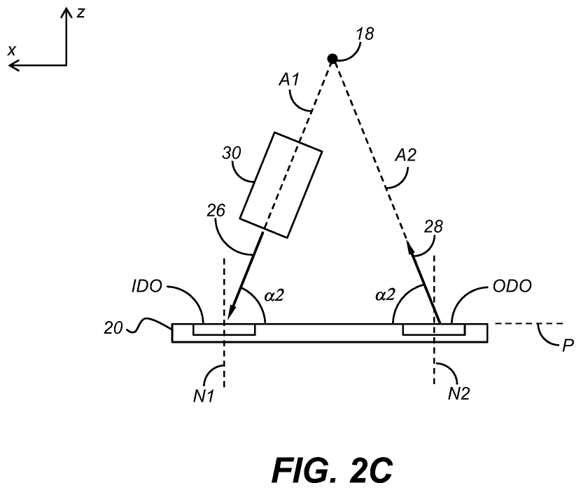

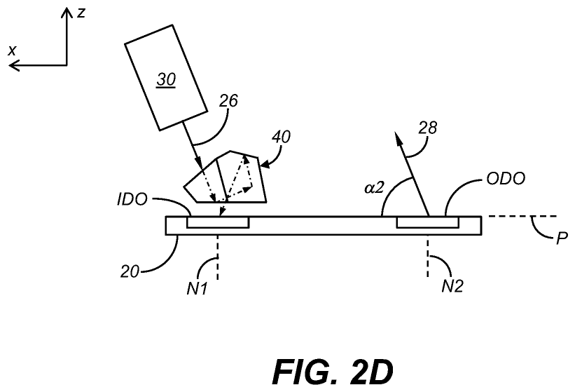

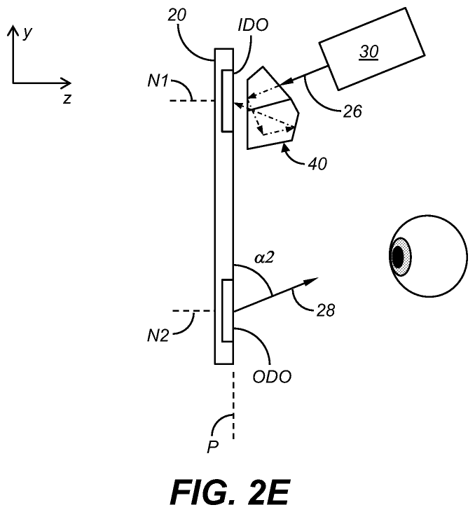

As illustrated in FIG. 2A, when a central ray of input image-bearing light 26 is directed at a normal N1 to the plane P, a central ray of the output image-bearing light 28 exits at a normal N2 to the plane P. While this arrangement is possible using the HMD of FIG. 1A, practical factors of viewer anatomy, component packaging and spacing, usability, and image quality generally cause input image-bearing light 26 to be incident to waveguide 20 at an oblique angle.

As illustrated in FIGS. 2B and 2C, when a central ray of input image-bearing light 26 is oriented at an oblique angle to plane P, a central ray of output image-bearing light 28 exits at a corresponding oblique angle. In the FIG. 2B configuration, the axis A1 of the input image-bearing light 26 is at an obtuse angle α1 with respect to a portion of the waveguide 20 surface that lies between in-coupling diffractive optic IDO and out-coupling diffractive optic ODO. Output image-bearing light 28 is at the same obtuse angle α1 with respect to the portion of the waveguide 20 surface that lies between in-coupling diffractive optic IDO and out-coupling diffractive optic ODO. Axis A1 intersects the axis A2 of the output image-bearing light 28 at a point 16 on the outer side of waveguide 20, within the field of view FOV of the observer.

In the FIG. 2C configuration, the axis A1 of the input image-bearing light 26 is at an acute angle α2 with respect to the portion of the waveguide 20 surface that lies between in-coupling diffractive optic IDO and out-coupling diffractive optic ODO. Output image-bearing light 28 is at the same acute angle α2 with respect to the portion of the waveguide 20 surface that lies between in-coupling diffractive optic IDO and out-coupling diffractive optic ODO. Here, axis A1 intersects the axis A2 of the output image-bearing light 28 on the observer side of waveguide 20, at a point 18.

Referring back to FIG. 1A, it can be seen that in the embodiment of HMD 10, waveguide 20 must exhibit the behavior shown in FIG. 2C in order to form the virtual image for the right eye 14R of the observer. That is, the input image-bearing light 26 must be at an acute angle relative to the portion of the waveguide 20 that lies between the in-coupling diffractive optic IDO and out-coupling diffractive optic ODO. With this relationship, output image-bearing light 28 is similarly at an acute angle with respect to the portion of the waveguide 20 that lies between the in-coupling diffractive optic IDO and out-coupling diffractive optic ODO and thus oblique with respect to normal N from the waveguide 20 surface. The axis of the input image-bearing light 26 intersects the axis of the output image-bearing light 28 on the observer side of waveguide 20, as described with reference to FIG. 2C.

As illustrated in FIG. 1A, in an example embodiment, a projector 30 is positioned along a temple 32 of HMD frame 58. The projector 30 is energizable to emit an image-bearing light beam along a projection axis A3. The output light beam from projector 30 along axis A3 is oriented at an angle that is obtuse with respect to the portion of the waveguide 20 that lies between the in-coupling diffractive optic IDO and out-coupling diffractive optic ODO. Thus, relative to waveguide 20, the angular orientation of axis A3 is opposite the orientation that is needed for properly directing image-bearing light to form the image within the eyebox, and needs to be redirected so that it is incident on waveguide 20 at an acute angle with respect to the portion of the waveguide 20 that lies between the in-coupling diffractive optic IDO and out-coupling diffractive optic ODO. In an embodiment, the projector 30 is a picoprojector using solid-state light sources and beam modulation, such as, without limitation, via a micromirror array or Digital Light Processing (DLP) device from Texas Instruments. In order to allow the use of picoprojector and other compact devices such as the projector 30, embodiments of the present disclosure employ an optical coupler 40 that redirects light from projector axis A3 to waveguide input axis A1.

With respect to FIGS. 1A and 2C, the function of an optical coupler 40 can be appreciated. The image-bearing light incident on the in-coupling diffractive optic IDO along axis A1 must be oriented at an acute angle α2 with respect to the portion of the waveguide 20 that lies between the in-coupling diffractive optic IDO and out-coupling diffractive optic ODO. However, as FIG. 1A shows, axis A3 from projector 30 is oriented at an obtuse angle (i.e., skewed in the opposite direction). In addition, projector 30 fits against the temple of the observer. As noted above, the projected image must be rotated 90 degrees, from a first orientation to a second orientation, in order to provide images using the preferred 9:16 aspect ratio.

As illustrated in FIG. 2D, in an embodiment, a compact optical coupler 40 is operable to orient the image-bearing light incident on the in-coupling diffractive optic IDO at an acute angle α2 with respect to the portion of the waveguide 20 that lies between the in-coupling diffractive optic IDO and out-coupling diffractive optic ODO. As illustrated in FIG. 2E, in an embodiment, the compact optical coupler 40 may be utilized in a HMD system wherein the projector 30 is located above the waveguide 20 along the y-axis direction. For example, the HMD system shown in FIG. 2E may be utilized in a helmet mounted HMD.

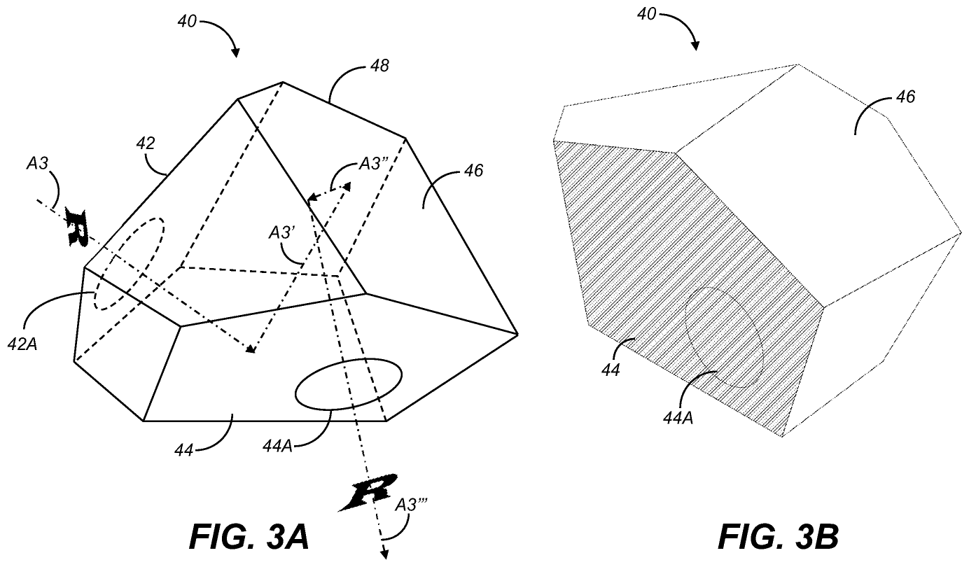

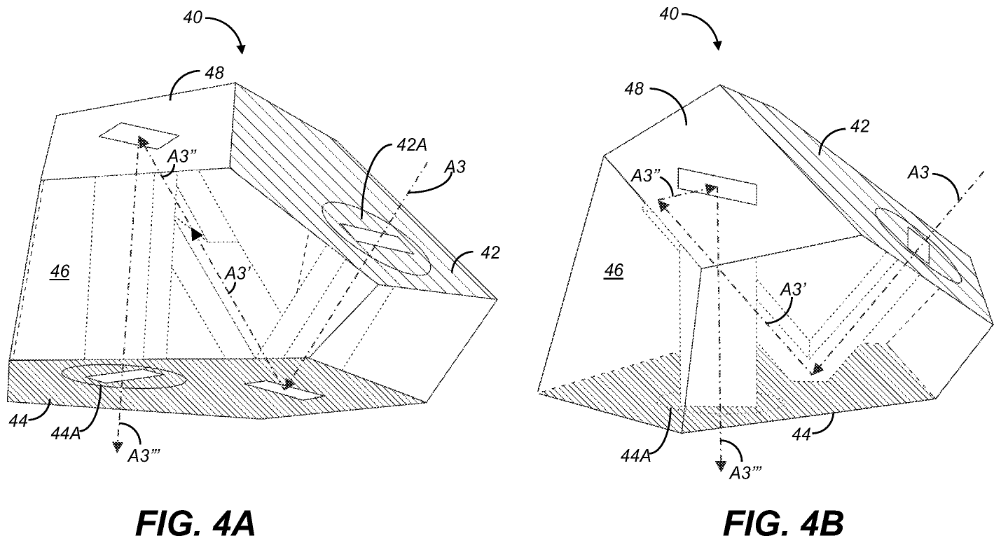

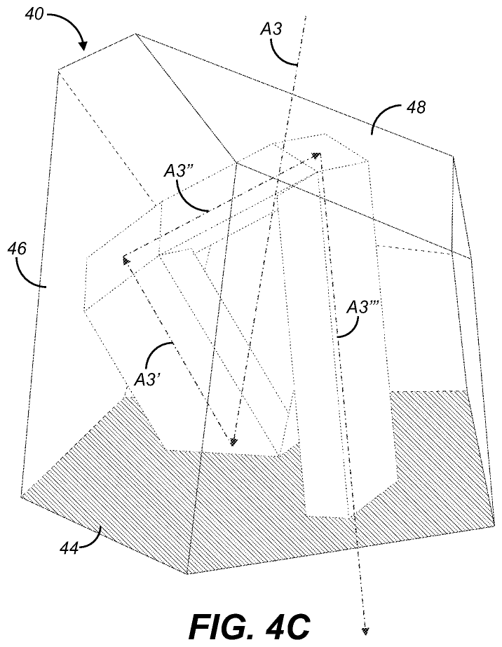

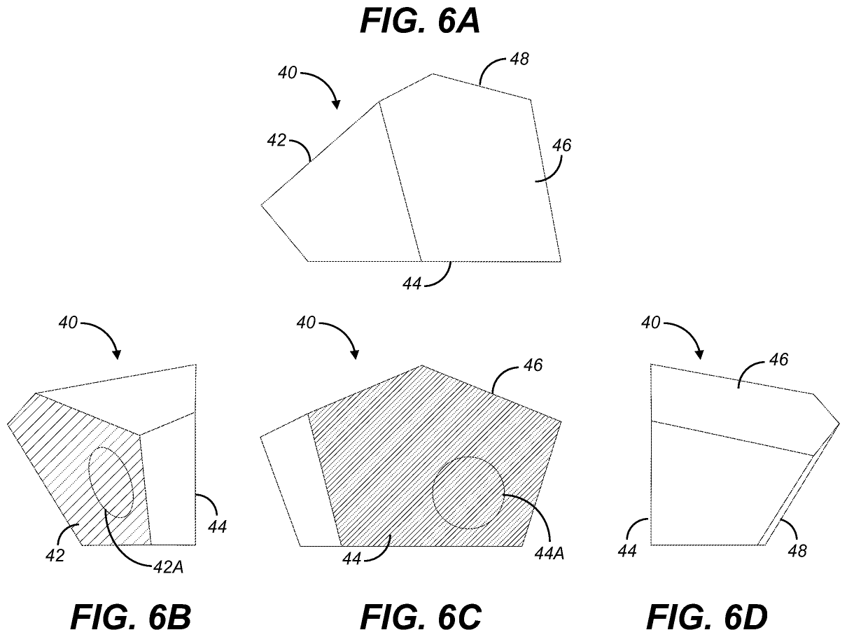

Referring now to FIGS. 3A-3B, 4A-4C, and 6A-6D, in an embodiment, the optical coupler 40 is formed as a polyhedron operable to rotate the image-bearing light. For example, the optical coupler 40 may be an irregular octahedron having twelve vertices and eighteen edges. The optical coupler 40 includes a first surface 42 having an input aperture 42A operable to receive image-bearing light from the projector 30 along the projection axis A3. The image-bearing light is reflected from a second surface 44 of the optical coupler 40, folding or redirecting the projection axis A3 (the redirected projection axis labeled axis A3′) toward a third surface 46 (shown in FIGS. 3A-4B). The third surface 46 reflects the image-bearing light and folds the projection axis A3′ toward a fourth surface 48 (the redirected projection axis labeled axis A3″). The fourth surface 48 folds and redirects the projection axis A3″ (the redirected projection axis labeled A3′″) toward an output aperture 44A located on/in the second surface 44. The output axis A3′″ is oriented at an acute angle with respect to the waveguide 20 surface as described above.

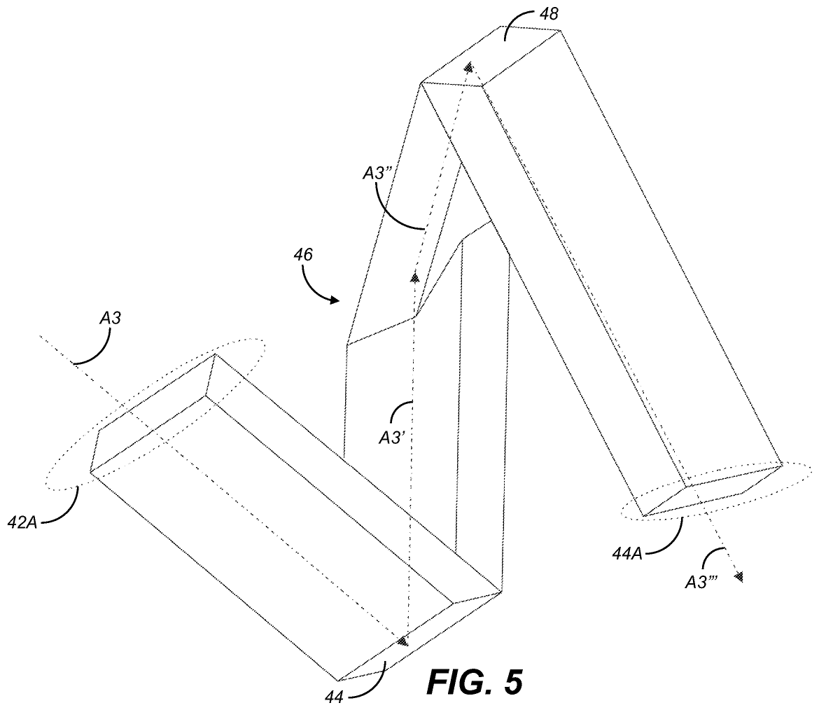

The image-bearing light directed along output axis A3′″ is rotated ninety-degrees from its orientation as input along the projection axis A3. Rotation of the image-bearing light is facilitated by at least three reflections within the optical coupler 40. For example, reflections at the second surface 44, the third surface 46, and the fourth surface 48. The “R” illustrated in FIG. 3A is representative of the orientation of a virtual image conveyed by the image-bearing light. In an embodiment, the angularly encoded image-bearing light beams comprise collimated beams (i.e., a bundle of parallel rays) having a unique orientation in two orthogonal planes. Within positions of overlap, such as at the output aperture 44A of the optical coupler 40, a lens placed at this position can form a real image, such as the image “R”, on a surface one focal length away. Referring now to FIG. 5, the rotation of and redirection/reorientation of the image-bearing light at any given point within the optical coupler 40 is visualized as an extruded rectangle. In an embodiment, the third surface 46 and the fourth surface 48 of the optical coupler 40 are mirrored surfaces (i.e., comprise optical mirrors). In an embodiment, the first surface 42 and the second surface 44 include an anti-reflection (AR) coating.

One advantage of the optical coupler 40 over known optical couplers assembled from two or more right angle prisms, is the reduced size/volume of the optical coupler 40. The reduced size/volume (i.e., compactness) of the optical coupler 40 is achieved, at least in part, by overlapping/compressing the optical path within the optical coupler 40 (i.e., the projection axes A3, A3′, A3″, A3′″) to minimize path length, and using the second surface 44 to reflect light along the projection axis A3 via TIR and output light along the projection axis A3′″. The size/volume of the optical coupler 40 is a function, at least in part, of the aperture 42A, 44A size. Therefore, simply “shrinking” conventional coupler designs fails to provide an operable compact optical coupler.

As illustrated in FIGS. 3A-3B, 4A-4C, and 6A-6D, in an embodiment, the optical coupler 40 is an irregular octahedron having all convex surfaces. The optical coupler 40 having no concave surfaces (e.g., all convex edges and vertices) enables, inter alia, the optical coupler 40 to be manufactured in a compact form having reduced size/volume utilizing a high index material (e.g., n>1.8) without greatly increasing manufacturing time and costs over conventional coupler designs.

Projectors, using a variety of display technologies, can be found in a form factor that is fairly compact, have a pupil size comparable to the entrance aperture of an optical waveguide, and have the brightness required to provide a reasonably bright image. However, within the projection optics of these projectors there is often a stop (this can be a physical aperture or a lens aperture acting as a stop) within the lens system. This means that the ray bundles for each field point in the virtual image begin to diverge within the projection optics before or at the last outermost lens surface of the projector. The ray bundles originating from the corners of the image generator are often clipped (vignetted) as they diverge from the projection optics. The further removed from the waveguide, the more divergence there is in the ray bundles. With this problem in mind, an embodiment of the present disclosure provides further advantages for HMD imaging with improvements to projector optics design.

In embodiments of the present disclosure, the stop can be positioned outside the projector, beyond the last optical surface of the projector that emits the projected image-bearing light beam. The stop may be an exit pupil rather than a physical stop. Embodiments shown herein position a mirrored surface at or near the remote pupil to form a stop. For the HMD 10, this design feature constrains the beam width of light that is delivered to the optical coupler 40 and enables the optical coupler 40 to be more compact. In an embodiment, a stop is positioned forward of the projection lens, such that the optical coupler 40 can re-position the stop substantially at the in-coupling diffractive optic IDO of the waveguide 20. By “substantially at the in-coupling diffractive optic IDO” is meant at least forward of the exit surface 44 of the optical coupler 40 or otherwise beyond the exit aperture 44A of the optical coupler 40.

In an embodiment, the projector 30 has a pupil forward of its objective lens such that the optical coupler 40 provides a virtual stop at an internal reflective surface 46, 48. In an embodiment, the projector 30 forms a pupil at one of the third surface 46 and the fourth surface 48 of the optical coupler 40.

In order to provide suitable imaging using the optical coupler 40, the spread of the optical path and the stop location must be considered. In general, higher index glass (n>1.8) is advantageous for reducing the optical path dimensions with the optical coupler 40. For example, the index of refraction of the optical coupler 40 may be 1.8, 2.0, 2.2, etc.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A virtual image display apparatus, comprising:
a projector operable to direct image-bearing light beams along a projection axis;
a waveguide having an in-coupling diffractive optic and an out-coupling diffractive optic, wherein the waveguide is oriented at an obtuse angle with respect to the projection axis; and
an optical coupler configured to (i) receive the image-bearing light beams along the projection axis, (ii) reorient the projection axis to an acute angle of incidence with respect to the waveguide, (iii) rotate the image-bearing light beams from a first orientation to a second orientation with respect to the projection axis, and (iv) direct the rotated image-bearing light beams along the reoriented projection axis to the in-coupling diffractive optic.

2. The virtual image display apparatus of claim 1, wherein the optical coupler further comprises a first surface configured to receive the image-bearing light along the projection axis, a second surface configured to redirect the projection axis toward a third surface, the third surface configured to redirect the projection axis toward a fourth surface, the fourth surface configured to redirect the projection axis toward the second surface.

3. The virtual image display apparatus of claim 2, wherein the third surface and the fourth surface comprise optical mirrors.

4. The virtual image display apparatus of claim 2, wherein the first surface and the second surface comprise an anti-reflection coating.

5. The virtual image display apparatus of claim 2, wherein the waveguide is configured to output the expanded image-bearing light beams through the out-coupling diffractive optic along a central output axis, and the redirected projection axis intersects the central output axis.

6. The virtual image display apparatus of claim 2, wherein the first surface comprises an input aperture configured to receive the image-bearing light along the projection axis, and the second surface comprises an output aperture configured to output the image-bearing light along the redirected projection axis.

7. The virtual image display apparatus of claim 2, wherein the second surface is configured to redirect the projection axis toward the third surface via total internal reflection.

8. The virtual image display apparatus of claim 1, wherein the optical coupler comprises an index of refraction of 1.8 or above.

9. The virtual image display apparatus of claim 1, wherein the waveguide accepts and outputs the image-bearing light from a surface on an observer side of the waveguide.

10. The virtual image display apparatus of claim 1, wherein an optical stop of the projector is disposed substantially at the in-coupling diffractive optic of the waveguide.

11. The virtual image display apparatus of claim 1, wherein the second orientation corresponds to a ninety degree rotation of the image-bearing light beams with respect to the first orientation.

12. The virtual image display apparatus of claim 1, wherein the optical coupler comprises an irregular octahedron.

13. The virtual image display apparatus of claim 12, wherein all edges and vertices of the optical coupler are convex.

14. The virtual image display apparatus of claim 1, wherein the projector forms a pupil within the optical coupler.

15. The virtual image display apparatus of claim 1, wherein the waveguide comprises a first planar surface and an opposing second planar surface.
